(19) United States
(12) Patent Application Publication
(10) Pub. No.: US 2022/0017326 A1
(43) Pub. Date: Jan. 20, 2022

(54) SYSTEMS AND METHODS FOR DISPATCHING ELEVATORS

(71) Applicant: Appana Industries LLC, Jamaica, NY (US)

(72) Inventor: Amarnauth APPANA, JR., Jamaica, NY (US)

(73) Assignee: Appana Industries LLC, Jamaica, NY (US)

(21) Appl. No.: 17/374,718

(22) Filed: Jul. 13, 2021

Related U.S. Application Data
(60) Provisional application No. 63/052,970, filed on Jul. 17, 2020.

(51) Int. Cl. B66B 1/24; B66B 1/46; B66B 5/00

(52) U.S. Cl. CPC B66B 1/2458; B66B 1/468; B66B 5/0012; B66B 2201/4607; B66B 2201/222; B66B 2201/226; B66B 2201/101

(57) ABSTRACT

A method for dispatching a plurality of elevator cars that includes receiving a call for at least one of the plurality of elevator cars. The call is from a first location of a plurality of locations. The method includes determining an occupant capacity for each of the plurality of elevator cars by determining a number of occupants within the plurality of elevator cars and determining a number of calls assigned to the plurality of elevator cars and positioned between a current location of the plurality of elevator cars and the first location. The method includes assigning the call from the first location to a first elevator car with an available occupant capacity that is greater than the occupant capacity of the plurality of elevator cars.

### CROSS-REFERENCE TO RELATED APPLICATIONS

This application claims the benefit of priority from U.S. Provisional Application No. 63/052,970, filed on Jul. 17, 2020, which is incorporated by reference herein in its entirety.

### TECHNICAL FIELD

Aspects of the present disclosure relate generally to systems and methods for controlling elevator traffic flow, and specifically to examples of elevator control systems that dispatch elevator cars based on a relative occupant capacity of a group of elevator cars.

### DESCRIPTION OF RELATED TECHNOLOGY

Elevator systems may generally employ a dispatch methodology based on a necessary travel time to answer a call request. In such systems, a location and an estimated travel time of each elevator car may be determined when a call request is received. An elevator car located within a vicinity of the call location, and having the smallest travel time to the call location, may be dispatched to a location of the call request. However, assigning elevator cars based on a location or travel time may result in dispatching elevator cars that are occupied at near or full capacity, thereby inhibiting the prospective passengers from boarding the elevator car. As a result, the prospective passengers may be required to attempt another call request for a separate elevator car, thereby resulting in decreased traffic flow and greater wait times for the prospective passengers. Providing a system capable of assigning elevator cars based on a relative occupant capacity may minimize instances of dispatching elevator cars at near or full capacity, thereby increasing traffic flow and decreasing wait times for prospective passengers.

### BRIEF DESCRIPTION OF DRAWINGS

The accompanying drawings, which are incorporated in and constitute a part of this disclosure, illustrate various exemplary embodiments and together with the description, serve to explain the principles of the disclosure.

Aspects of the disclosure may be implemented in connection with embodiments illustrated in the attached drawings. These drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a dispatch system including one or more devices in communication over a network.

FIG. 2 is a schematic view of a working environment including multiple elevator cars interacting with the dispatch system shown in FIG. 1.

FIG. 3 is a top view of an interior of an elevator car from the working environment shown in FIG. 2.

FIG. 4 is a schematic view of hardware components of a computing device from the dispatch system shown in FIG. 1.

FIG. 5 is a flow diagram of an exemplary method of dispatching elevator cars with the dispatch system shown in FIG. 1.

### SUMMARY

According to an example, a method for dispatching a plurality of elevator cars includes receiving a call for at least one of the plurality of elevator cars. The call is from a first location of a plurality of locations. The method includes determining an occupant capacity for each of the plurality of elevator cars by determining a number of occupants within the plurality of elevator cars, and determining a number of calls assigned to the plurality of elevator cars and positioned between a current location of the plurality of elevator cars and the first location. The method further includes assigning the call from the first location to a first elevator car with an available occupant capacity that is greater than the occupant capacity of the plurality of elevator cars.

According to another example, a system for dispatching a plurality of elevator cars includes at least one call device positioned at a plurality of locations. The at least one call device is configured to transmit a call for at least one of the plurality of elevator cars from a first location of the plurality of locations. The system includes at least one counter device positioned in the plurality of elevator cars. The at least one counter device is configured to count a number of occupants in the plurality of elevator cars. The system includes a dispatch controller operably coupled to the at least one call device at the plurality of locations and the at least one counter device in the plurality of elevator cars such that the dispatch receives data indicative of the call and the number of occupants in the plurality of elevator cars. The dispatch controller is configured to determine an occupant capacity for each of the plurality of elevator cars from the number of occupants in the plurality of elevator cars, and a number of calls assigned to the plurality of elevator cars and positioned between a current location of the plurality of elevator cars and the first location. The dispatch controller is configured to assign the call from the first location to a first elevator car with an available occupant capacity that is greater than the occupant capacity of the plurality of elevator cars.

According to a further example, a system for controlling traffic flow of a plurality of elevator cars includes a processor and a memory storing instructions that, when executed by the processor, causes the processor to perform operations including receiving a call for at least one of the plurality of elevator cars. The call is from a first location of a plurality of locations. The operations includes determining an occupant capacity for each of the plurality of elevator cars by determining a number of occupants within the plurality of elevator cars, and determining a number of calls assigned to the plurality of elevator cars and positioned between a current location of the plurality of elevator cars and the first location. The operations include assigning the call from the first location to a first elevator car with an available occupant capacity that is greater than the occupant capacity of the plurality of elevator cars.

### DETAILED DESCRIPTION

The dispatch system of the present disclosure may be in the form of varying embodiments, some of which are depicted by the figures and further described below.

Both the foregoing general description and the following detailed description are exemplary and explanatory only and are not restrictive of the features, as claimed. As used herein, the terms “comprises,” “comprising,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/−10% (unless a different variation is specified) from the disclosed numeric value. Moreover, in the claims, values, limits, and/or ranges mean the value, limit, and/or range +/−10%.

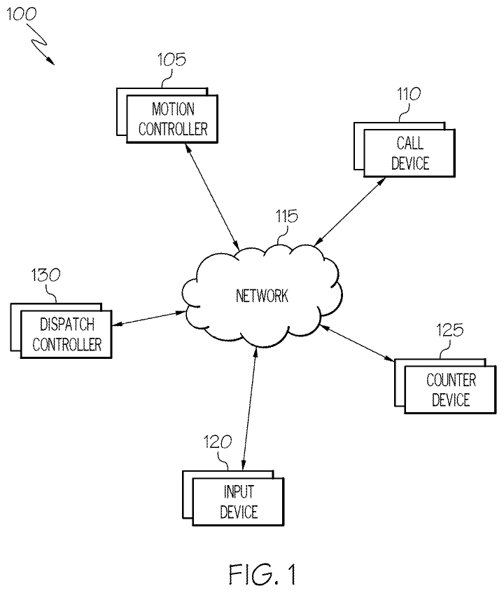

FIG. 1 shows an exemplary dispatch system 100 that may include motion controller 105, call device 110, input device 120, counter device 125, and dispatch controller 130. The one or more devices of dispatch system 100 may communicate with one another across a network 115 and in any arrangement. For example, the devices of dispatch system 100 may be communicatively coupled to one another via a wired connection, a wireless connection, or the like. In some embodiments, network 115 may be a wide area network (“WAN”), a local area network (“LAN”), personal area network (“PAN”), etc. Network 115 may further include the Internet such that information and/or data provided between the devices of dispatch system 100 may occur online (e.g., from a location remote from other devices or networks coupled to the Internet). In other embodiments, network 115 may utilize Bluetooth® technology and/or radio waves frequencies.

Motion controller 105 may be operably coupled to a transportation unit and configured to detect and transmit motion data of the transportation unit to one or more devices of dispatch system 100, such as, for example, dispatch controller 130. For example, motion controller 105 may measure and record one or more parameters (e.g., motion data) of the transportation unit, including, but not limited to, a current location, a travel direction, a travel speed, a door location, a status, and more. Motion controller 105 may include a computing device having one or more hardware components (e.g., a processor, a memory, a sensor, a communications module, etc.) for generating, storing, and transmitting the motion data. As described in further detail herein, motion controller 105 may be operably coupled to an elevator car located within a building and dispatch system 100 may include at least one motion controller 105 for each elevator car.

Still referring to FIG. 1, call device 110 may be positioned outside the transportation unit and configured to receive a user input from one or more prospective occupants for accessing the transportation unit. For example, the user input may be indicative of a call requesting transportation from the transportation unit. Call device 100 may be configured to transmit the call request to one or more devices of dispatch system 100, such as, for example, dispatch controller 130. Call device 110 may include a keypad, a touchscreen display, a microphone, a button, a switch, etc. Call device 110 may be further configured to receive a user input indicative of a current location of the call request (e.g., a first location) and/or a destination location (e.g., a second location) from a plurality of locations.

As described in further detail herein, call device 110 may be located within a building and dispatch system 100 may include at least one call device 100 for each floor of the building. Call device 100 may be configured to transmit a message from one or more devices of dispatch system 100 (e.g., dispatch controller 130) identifying an elevator car assigned to arrive at the floor of the building to answer the call request. The message may be communicated by call device 100 via various suitable formats, including, for example, in a written form, an audible form, a graphic form, and more.

Input device 120 may be positioned inside the transportation unit and configured to receive a user input from one or more occupants of the transportation unit. For example, the user input may be indicative of a command requesting redirection of the transportation unit. Input device 120 may be configured to transmit the command to one or more devices of dispatch system 100, such as, for example, dispatch controller 130. Input device 120 may include a keypad, a touchscreen display, a microphone, a button, a switch, etc. As described in detail herein, input device 120 may be located within an elevator car and dispatch system 100 may include at least one input device 100 for each elevator car in a building. In other embodiments, input device 120 may be omitted entirely from dispatch system 100.

Still referring to FIG. 1, counter device 125 may be positioned inside the transportation unit and configured to detect and transmit occupant data of the transportation unit to one or more devices of dispatch system 100, such as, for example, dispatch controller 130. For example, counter device 125 may measure and record a number of objects located within the transportation unit, including, but not limited to, an occupant, a personal belonging, a luggage, a baggage, and more. Counter device 125 may include an optical system facing an interior of the transportation unit, such as, for example, a sensor, a camera, a light beam, an infrared detector, etc. As described in further detail herein, counter device 125 may be coupled to an elevator car that is located within a building and dispatch system 100 may include at least one counter device 125 for each elevator car of the building.

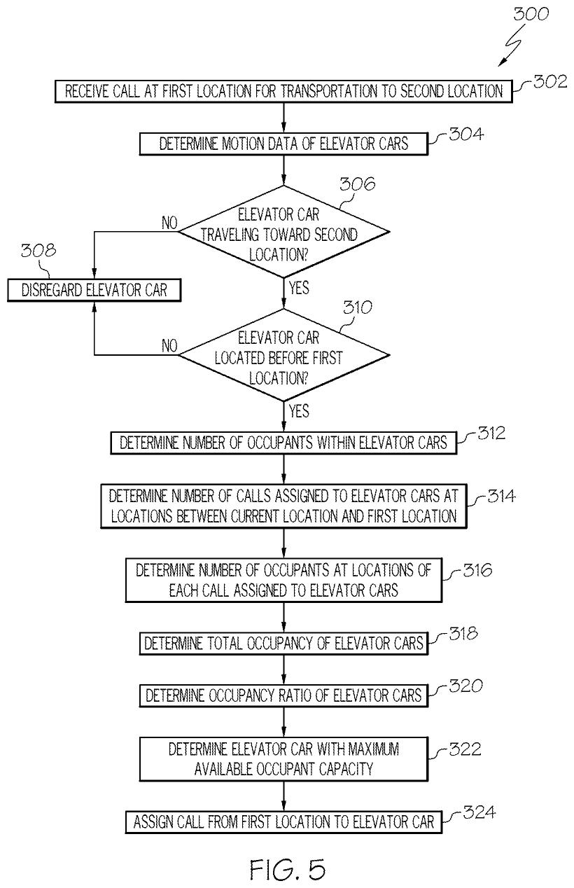

Dispatch controller 130 may be positioned outside the transportation unit and configured to receive data (e.g., motion data, a call request, a redirection command, occupant data, etc.) from one or more devices of dispatch system 100. Dispatch controller 130 may be further configured to determine at least one transportation unit of a plurality of transportation units to dispatch to a location of a call request received from a prospective occupant seeking transportation. Dispatch controller 130 may include a computing device (see FIG. 4) operable to perform one or more processes (see FIG. 5) for dispatching at least one transportation unit having a maximum available capacity to the location of the prospective passenger. As described in further detail herein, dispatch controller 130 may be operably coupled to a plurality of elevator cars located within a building and dispatch system 100 may include at least one dispatch controller 130 for each building.

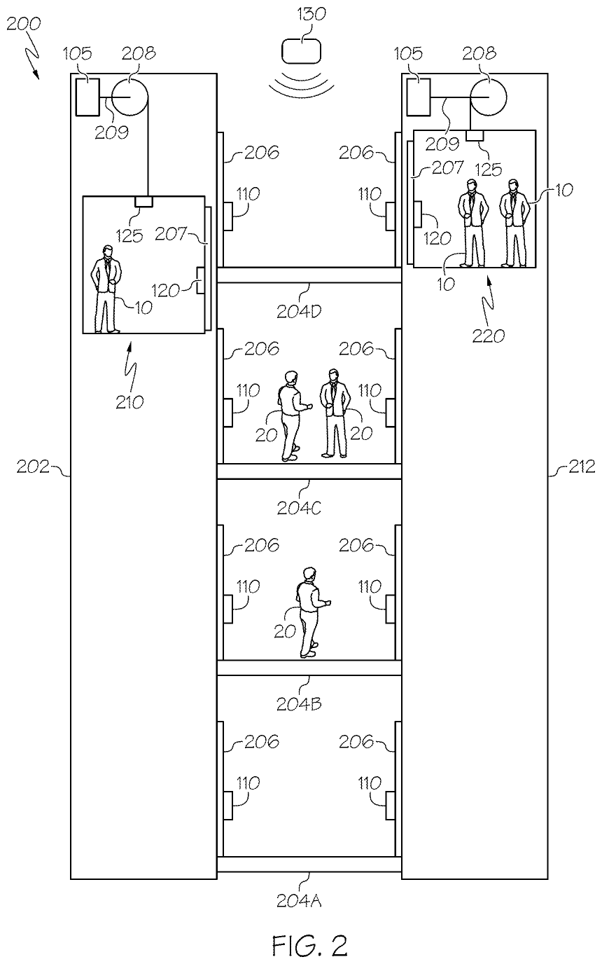

Referring now to FIG. 2, dispatch system 100 may be utilized in a working environment 200, such as a building (e.g., a facility, a factory, a store, a school, a house, an office, and various other structures). In the example, the transportation unit may include one or more elevator cars within the building. It should be appreciated that working environment 200 is merely illustrative such that dispatch system 100 may be utilized in various other suitable environments than those shown and described herein without departing from a scope of this disclosure. In the example, working environment 200 may include a plurality of floors defining a plurality of locations within the building, such as first floor 204A, second floor 204B, third floor 204C, and fourth floor 204D. It should be appreciated that, in other embodiments, the building of working environment 200 may include additional and/or fewer floors.

Working environment 200 may further include one or more elevator shafts with at least one elevator car positioned within each elevator shaft. In the example, working environment 200 includes a first elevator shaft 212 with at a first elevator car 210 and a second elevator shaft 212 with a second elevator car 220. Although not shown, it should be appreciated that working environment 200 may include additional (e.g., a plurality) elevator shafts and/or elevator cars. Each elevator car 210, 220 may be coupled to a pulley system 208 configured to move elevator cars 210, 220 within elevator shafts 202, 212 and relative to floors 204A-204D. It should be understood that pulley system 208 may include various mechanical and/or electrical mechanisms for moving elevator cars 210, 220 within elevator shafts 202, 212, including but not limited to, a motor, a cable, a counterweight, a sheave, etc.

Still referring to FIG. 2, each elevator car 210, 220 may include at least one motion controller 105 operably coupled to pulley system 208, such as, for example, via a wireless connection and/or a wired connection 209. Motion controller 105 may be configured to measure motion data from elevator cars 210, 220 by detecting a relative movement of pulley system 208. Each elevator car 210, 220 may further include at least one input device 120 positioned within a cabin of elevator car 210, 220 for receiving a user input from one or more occupants 10 located within the cabin.

Each floor 204A-204D may include one or more call devices 110 and access doors 206 providing accessibility to elevator cars 210, 220 when an elevator door 207 of elevator car 210, 220 is aligned with the respective floor 204A-204D. Call device 110 may be configured to receive a user input from one or more prospective occupants 20 located at one of the plurality of floors 204A-204D. For example, call device 110 may be configured to receive a user input indicative of a call requesting transportation via at least one of elevator cars 210, 220. Call device 100 may be configured to transmit the call request to dispatch controller 130, which may include data indicative of a current location (i.e., a first location) within working environment 200 from which the call request originated from (e.g., second floor 204B). The call request may further include data indicative of a destination location (i.e., a second location) within working environment 200 to which the prospective passenger is seeking transportation to (e.g., first floor 204A).

Still referring to FIG. 2, each elevator car 210, 220 may further include at least one counter device 125 positioned within a cabin. Counter device 125 may be positioned along an inner wall (e.g., a ceiling) of each elevator car 210, 220 and configured to detect a number of occupants 10 within the cabin. In some embodiments, counter device 125 may be operable to distinguish between one or more objects detected within elevator cars 210, 220.

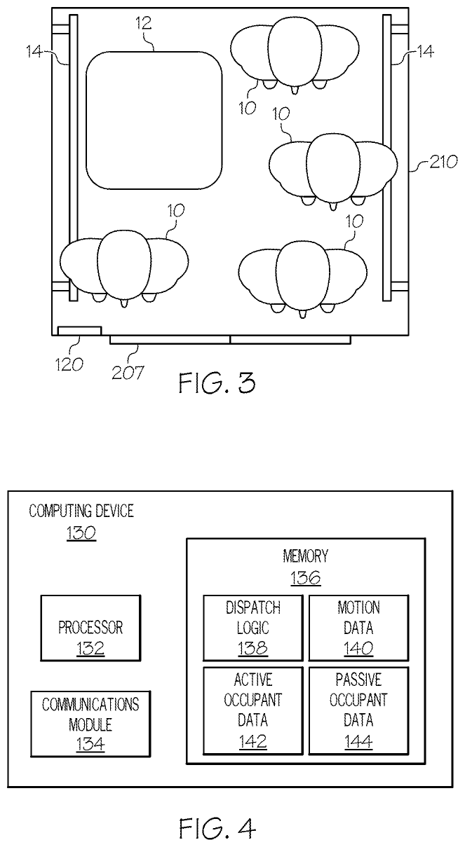

For example, as seen in FIG. 3, counter device 125 may be configured to detect items present within the cabin and occupying a capacity of elevator cars 210, 220 (e.g., occupants 10, ancillary objects 12, etc.) and items within the cabin that may not occupy a capacity of elevator cars 210, 220 (e.g., rails 14, etc.). Counter device 125 may measure a number of items detected within elevator cars 210, 220 and record such measurements as occupant data. As discussed further herein, counter device 125 may be configured to transmit occupant data (e.g., active occupant data 142, passive occupant data 144, etc.) for each elevator car 210, 220 to dispatch controller 130 via network 115.

Referring now to FIG. 4, dispatch controller 130 may include a computing device incorporating a plurality of hardware components that allow dispatch controller 130 to receive data (e.g., motion data, call requests, commands, occupant data, etc.), process information (e.g., occupant capacity), and/or execute one or more processes (see FIG. 5). Illustrative hardware components of dispatch controller 130 may include at least one processor 132, at least one communications module 134, and at least one memory 136. In some embodiments, dispatch controller 130 may include a computer, a mobile user device, a remote station, a server, a cloud storage, and the like. In the illustrated embodiment, dispatch controller 130 is shown and described herein as a separate device from the other devices of dispatch system 100, while in other embodiments, one or more aspects of dispatch controller 130 may be integrated with one or more of the other devices of dispatch system 100. Stated differently, the illustrative hardware components of dispatch controller 130 shown and described herein may be integral with one or more of motion controller 105, call device 110, input device 120, and/or counter device 125.

Processor 132 may include any computing device capable of executing machine-readable instructions, which may be stored on a non-transitory computer-readable medium, such as, for example, memory 136. By way of example, processor 132 may include a controller, an integrated circuit, a microchip, a computer, and/or any other computer processing unit operable to perform calculations and logic operations required to execute a program. As described in detail herein, processor 132 is configured to perform one or more operations in accordance with the instructions stored on memory 136, such as, for example, dispatch logic 138.

Still referring to FIG. 4, memory 136 may include various programming algorithms and data that support an operation of dispatch system 100. Memory 136 may include any type of computer readable medium suitable for storing data and algorithms, such as, for example, random access memory (RAM), read only memory (ROM), a flash memory, a hard drive, and/or any device capable of storing machine-readable instructions. Memory 136 may include one or more data sets, including, but not limited to, motion data 140 received from motion controller 105, active occupant data 142 and/or passive occupant data 144 captured from counter device 125, and the like.

As described further herein, active occupant data 142 may include a real-time number of occupants 10 detected within a cabin of each elevator car 210, 220 by counter device 125. Passive occupant data 144 may include a number of occupants 10 previously detected within at least one elevator car 210, 220 by counter device 125, and whom were transported to at least one of a plurality of locations within working environment 200. Stated differently, passive occupant data 144 may correspond to a number of occupants 10 transported by at least one of the plurality of elevator cars 210, 220 to at least one of the plurality of floors 204A-204D. Dispatch controller 130 may be configured to store the passive occupant data 144 in memory 136 and associate the number of occupants 10 with their corresponding destination within working environment 200 (e.g., floors 204A-204D). For example, dispatch controller 130 may receive and correlate the motion data 140 received from motion controller 105 with the passive occupant data 144 to determine a destination location of the occupants 10.

Further, memory 136 may include a non-transitory computer readable medium that stores machine-readable instructions thereon, such as, dispatch logic 140. In one example, dispatch logic 140 may include executable instructions that allow dispatch system 100 to determine which elevator car from the plurality of elevator cars 210, 220 to dispatch in response to receiving a call request at a first location for transportation to a second location. Dispatch logic 140 may further facilitate determining an occupant capacity of each elevator car 210, 220 based on a number of occupants physically present within each elevator car 210, 220 and a number of occupants designated for retrieval by, and located outside of, each elevator car 210, 220. As described in further detail herein, dispatch system 100 may be configured to determine the occupant capacity of each elevator car 210, 220 based on one or more of motion data 140, active occupant data 142, and/or passive occupant data 144 received by dispatch controller 130 from motion controller(s) 105 and counter device(s) 125.

Referring now to FIG. 5, an example method 300 of using dispatch system 100 to determine an occupant capacity of a plurality of elevator cars and to dispatch an elevator car having a greater occupant capacity is depicted. It should be understood that the steps shown and described herein, and the sequence in which they are presented, are merely illustrative such that additional and/or fewer steps may be included in various arrangements without departing from a scope of this disclosure.

At step 302, dispatch system 100 may receive a call request at a first location of a plurality of locations within working environment 200. The call request may be initiated in response to a prospective occupant 20 actuating call device 110 at the first location, such as, for example, at second floor 204B. Call device 100 may transmit the call request to dispatch controller 130 via network 115 and the call request may include data indicative of the first location (e.g., second floor 204B) from which the call request originated from. The call request may further include data indicative of a second location (e.g., first floor 204A) within working environment 200 to which the prospective occupant 20 seeks to travel to (i.e., a destination of the prospective occupant 20).

At step 304, dispatch controller 130 may retrieve motion data 140 of each elevator car 210, 220 from a corresponding motion controller 105. Dispatch controller 130 may be configured to determine various movement parameters of each elevator car 210, 220 from the motion data 140, such as, for example, a current location of first elevator car 210 relative to first elevator shaft 202 (e.g., moving between fourth floor 204D and third floor 204C), a current travel direction of first elevator car 210 (e.g., toward first floor 204A), a current travel speed of first elevator car 210, and more. Dispatch controller 130 may further determine a current location of second elevator car 220 relative to second elevator shaft 212 (e.g., stationary at fourth floor 204D), a current travel direction of second elevator car 220 (e.g., toward first floor 204A), a current travel speed of second elevator car 220, and more.

At step 306, dispatch controller 130 may be configured to analyze motion data 140 of each elevator car 210, 220 to determine whether a current travel direction of elevator cars 210, 220 is toward the second location (e.g., first floor 204A). In response to determining elevator car 210, 220 is not traveling toward the second location, dispatch controller 130 may be configured to disregard the particular elevator car 210, 220 from further consideration, at step 308. Stated differently, dispatch controller 130 may determine that any elevator car of the plurality of elevator cars 210, 220 traveling in a different direction than toward the second location (relative to the current location of the elevator car 210, 220) may not be an optimal elevator car to answer the call request. In the example, first elevator car 210 and second elevator car 220 may include occupants 10 traveling from fourth floor 204D to first floor 204A such that dispatch controller 130 may determine that each elevator car 210, 220 is traveling toward the second location.

Still referring to FIG. 5, at step 310, dispatch controller 130 may be configured to determine whether a current location of each elevator car 210, 220 is located prior to the first location (e.g., second floor 204B) or whether elevator cars 210, 220 have moved beyond the first location. Stated differently, dispatch controller 130 may determine that any elevator car of the plurality of elevator cars 210, 220 that is currently positioned beyond the first location may not be an optimal elevator car to answer the call request. In response to determining one or more of elevator cars 210, 220 are not located before the first location, dispatch controller 130 may be configured to disregard the particular elevator car 210, 220 from further consideration, at step 308.

In the example, first elevator car 210 is positioned between fourth floor 204D and third floor 204C and second elevator car 220 is positioned at fourth floor 204D such that dispatch controller 130 may determine that each elevator car 210, 220 is currently located before the first location. At steps 312 to 320, dispatch controller 130 may be configured to determine an occupant capacity of each elevator car 210, 220 in response to determining elevator cars 210, 220 are positioned at a location in elevator shaft 202, 220 prior to the first location (e.g., second floor 204B).

For example, at step 312, dispatch controller 130 may be configured to determine a number of occupants 10 within each elevator car 210, 220 by retrieving active occupant data 142 from the respective counter device 125 located within each elevator car 210, 220. In some embodiments, counter device 125 may be configured to detect a total number of occupants 10 and/or objects 12 located within each elevator car 210, 220 (see FIG. 3). Thus, dispatch controller 130 may consider one or more objects 12 detected by counter device 125 when determining the number of occupants 10 at step 312. Each counter device 125 may transmit a signal to dispatch controller 130 via network 115 indicative of the active occupant data 142 for the respective elevator car 210, 220. In the example, dispatch controller 130 may determine first elevator car 210 includes a single occupant 10 and second elevator car 220 includes two occupants 10.

Still referring to FIG. 5, at step 314, dispatch controller 130 may be configured to determine a number of calls previously assigned to each elevator car 210, 220 (e.g., by dispatch controller 130) and that have a (pickup) location positioned between a current location of each elevator car 210, 220 and the first location. Stated differently, dispatch controller 130 may determine how many, if any, intermediate stops each elevator car 210, 220 is expected to perform between its current location and the first location (e.g., second floor 204B). It should be understood that the number of calls previously assigned to elevator cars 210, 220 is relative to when the call request at step 302 is received by dispatch controller 130. It should further be appreciated that any calls previously assigned to elevator cars 210, 220 and which do not include a location positioned between the current location of elevator car 210, 220 and the first location of the call request do not provide an intermediate stop. Accordingly, dispatch controller 130 may be configured to disregard any prior calls assigned to elevator cars 210, 220 which have a (pickup) location after the first location when determining the number of calls at step 314.

In the example, first elevator car 210 may include a previously-assigned call at third floor 204C such that dispatch controller 130 may determine that first elevator car 210 includes one assigned call located between the current location of first elevator car 210 (e.g., between fourth floor 204D and third floor 204C) and the first location (e.g., second floor 204B). Further, second elevator car 220 may not include any previously-assigned calls such that dispatch controller 130 may determine that second elevator car 220 includes zero assigned calls located between the current location of second elevator car 220 (e.g., fourth floor 204D) and the first location (e.g., second floor 204B).

At step 316, dispatch controller 130 may be configured to determine a number of prospective occupants 20 at the location of each call previously assigned to elevator car 210 (step 314). In some embodiments, dispatch controller 130 may determine that the location of each call previously assigned to elevator car 210 may include at least one prospective occupant 20. In this instance, at step 318, dispatch controller 130 may determine a total occupancy of each elevator car 210, 220 by computing an aggregate of the number of occupants 10 physically present within elevator cars 210, 220 (step 312) and the number of prospective occupants 20 located at each previously-assigned call (step 314). In this instance, dispatch controller 130 may determine first elevator car 210 includes a total occupancy of two, e.g., one occupant 10 within first elevator car 210 and at least one prospective occupant 20 at third floor 204C. Dispatch controller 130 may further determine second elevator car 220 includes a total occupancy of two, e.g., two occupants 10 within second elevator car 220 and no prospective occupants 20.

In other embodiments, dispatch controller 130 may determine that the location of each call previously assigned to elevator car 210 may include a maximum number of prospective occupants 20 at step 316. In this instance, dispatch controller 130 may determine the maximum number of prospective occupants 20 at the location of each call previously assigned to elevator car 210 corresponds to the passive occupant data 144 stored on memory 136 for that particular location (e.g., third floor 204C). In the example, passive occupant data 144 may indicate an aggregate of two occupants 20 previously traveling to third floor 204C by at least one of the plurality of elevator cars 210, 220 at a point prior to receiving the call request at step 302. Accordingly, dispatch controller 130 may determine the call assigned to first elevator car 210 from third floor 204C may include two prospective occupants 20.

At step 318, dispatch controller 130 may determine first elevator car 210 includes a total occupancy of three, e.g., one occupant 10 within first elevator car 210 and a maximum of two prospective occupants 20 at third floor 204C. It should be appreciated that the passive occupant data 144 stored on memory 136 may be periodically updated by dispatch system 100 throughout continued use of the plurality of elevator cars 210, 220 in working environment 200. Accordingly, the passive occupant data 144 for each of the plurality of floors 204A-204B may be dynamic and continuously modified to track a current number of occupants 20 located at each floor 204A-204D. It should be understood that the current number of occupants 20 may increase and/or decrease based on the number of occupants 10 traveling to and from each floor 204A-204D via the plurality of elevator cars 210, 220, as detected by counter device 125.

Still referring to FIG. 5, at step 320, dispatch controller 130 may be configured to determine an occupancy ratio of each of the plurality of elevator cars 210, 220 based on at least the total occupancy (step 318) and a maximum occupant capacity of each elevator car 210, 220. In some embodiments, a maximum occupant capacity of each elevator car 210, 220 may be communicated to dispatch controller 130 from counter device 125 via network 115. In other embodiments, dispatch controller 130 may store the maximum occupant capacity in memory 136 for each of the plurality of elevator cars 210, 220. It should be appreciated that a size and/or shape of the cabin of each of the plurality of elevator cars 210, 220 may be determinative of a maximum occupant capacity. In the example, the plurality of elevator cars 210, 220 may include a substantially similar size and/or shape such that the maximum occupant capacity of first elevator car 210 and second elevator car 220 are relatively similar. In other examples, the plurality of elevator cars 210, 220 may include a varying sizes and/or shapes such that the maximum occupant capacity of first elevator car 210 and second elevator car 220 may differ relative to one another.

In the example, with first elevator car 210 having a total occupancy of two occupants and a maximum occupant capacity of six occupants, dispatch controller 130 may be configured to determine first elevator car 210 has an occupancy ratio of approximately 2:6 (e.g., approximately 33.33%). Alternatively, with first elevator car 210 having a total having a total occupancy of three occupants and a maximum occupant capacity of six occupants, dispatch controller 130 may be configured to determine first elevator car 210 has an occupancy ratio of approximately 3:6 (e.g., approximately 50%). Further, with second elevator car 220 having a total occupancy of two occupants and a maximum occupant capacity of six occupants, dispatch controller 130 may be further configured to determine second elevator car 220 has an occupancy ratio of approximately 2:6 (e.g., approximately 33.33%).

Still referring to FIG. 5, at step 322, dispatch controller 130 may be configured to determine at least one of the plurality of elevator cars 210, 220 having a maximum available occupant capacity to assign the call request to. Dispatch controller 130 may compare the occupancy ratios of each of the plurality of elevator cars 210, 220 to determine the at least one elevator car 210, 220 having the maximum available occupant capacity. In the example, with first elevator car 210 and second elevator 220 each having an occupancy ratio of approximately 50%, dispatch controller 130 may be configured to compare the motion data 140 to determine one or more motion parameters of the plurality of elevator cars 210, 220 (e.g., a current location, a travel speed, a status, etc.).

Dispatch controller 130 may compare the motion data 140 to determine which of the plurality of elevator cars 210, 220 to assign to the call request to when elevator cars 210, 220 have a similar maximum available occupant capacity. For example, dispatch controller 130 may assign the call request to first elevator car 210 based on a distance between first elevator car 210 and the first location (e.g., second floor 204C) being less than a distance between second elevator car 220 and the first location. By way of further example, with first elevator car 210 having a previously-assigned call and second elevator car 220 not having a previously-assigned call, dispatch controller 130 may determine to assign the call request to second elevator car 220 based on a travel speed of second elevator car 220 being greater than first elevator car 210.

In examples where first elevator car 210 includes an occupancy ratio of approximately 33.33% and second elevator 220 includes an occupancy ratio of approximately 50%, dispatch controller 130 may be configured to assign the call request to second elevator car 220 having the greater maximum available occupant capacity. In this instance, second elevator car 220 may be assigned the call request at step 324. In some embodiments, dispatch controller 130 may compare the motion data 140 of the plurality of elevator cars 210, 220 when the occupancy ratio of the plurality of elevator cars 210, 220 vary relative to one another. In this instance, dispatch controller 130 may be configured to assign the call request to at least one elevator car 210, 220 despite another one of the plurality of elevator cars 210, 220 having the greater maximum available occupant capacity.

In some embodiments, dispatch controller 130 may be configured to communicate with call device 100 to transmit a message to the prospective occupant 20 at the first location (e.g., second floor 204B). For example, dispatch controller 130 may communicate an identification of the at least one of the plurality of elevator cars 210, 220 assigned to answer the call request. In other embodiments, dispatch controller 130 may identify the at least one of the plurality of elevator shafts 202, 212 from which the elevator car 210, 220 may arrive from. The message may be transmitted via call device 110 in various suitable formats, including, for example, via a display (e.g., a written form, a graphic form, etc.), a speaker (e.g., an audible form), and more.

All technical and scientific terms used herein have the same meaning as commonly understood to one of ordinary skill in the art to which this disclosure belongs unless clearly indicated otherwise. As used herein, the singular forms “a”, “an”, and “the” include plural references unless the context clearly dictates otherwise.

The above description is illustrative and is not intended to be restrictive. One of ordinary skill in the art may make numerous modifications and/or changes without departing from the general scope of the disclosure. For example, and as has been described, the above-described embodiments (and/or aspects thereof) may be used in combination with each other. Additionally, portions of the above-described embodiments may be removed without departing from the scope of the disclosure. In addition, modifications may be made to adapt a particular situation or material to the teachings of the various embodiments without departing from their scope. Many other embodiments will also be apparent to those of skill in the art upon reviewing the above description.

What is claimed is:

1. A method for dispatching a plurality of elevator cars, the method comprising:
receiving a call for at least one of the plurality of elevator cars, wherein the call is from a first location of a plurality of locations;
determining an occupant capacity for each of the plurality of elevator cars by:
determining a number of occupants within the plurality of elevator cars; and
determining a number of calls assigned to the plurality of elevator cars and positioned between a current location of the plurality of elevator cars and the first location; and
assigning the call from the first location to a first elevator car with an available occupant capacity that is greater than the occupant capacity of the plurality of elevator cars.

2. The method of claim 1, further comprising:
determining a total occupancy for each of the plurality of elevator cars by computing an aggregate of
the number of occupants within the plurality of elevator cars; and
the number of calls assigned to the plurality of elevator cars and positioned between the current location of the plurality of elevator cars and the first location.

3. The method of claim 2, further comprising:
determining a ratio between the total occupancy of each of the plurality of elevator cars with a maximum occupancy capacity of each of the plurality of elevator cars.

4. The method of claim 3, further comprising:
determining the first elevator car has an available ratio that is greater than the ratio of the plurality of elevator cars in response to comparing the ratio of each of the plurality of elevator cars relative to one another.

5. The method of claim 1, wherein each of the calls assigned to the plurality of elevator cars includes data indicative of a number of occupants at a location of the call.

6. The method of claim 5, further comprising:
determining a number of occupants at the location of each of the calls assigned to the plurality of elevator cars.

7. The method of claim 6, wherein the number of occupants at the location of each of the calls is at least one.

8. The method of claim 6, wherein each of the plurality of elevator cars include a counter device configured to generate the data indicative of the number of occupants at the location of each of the calls.

9. The method of claim 6, further comprising:
determining a total occupancy by computing an aggregate of the number of occupants within each of the plurality of elevator cars and the number of occupants at the location of each of the calls assigned to the plurality of elevator cars.

10. The method of claim 9, further comprising:
determining a ratio of the total occupancy of each of the plurality of elevator cars relative to a maximum occupancy capacity of each of the plurality of elevator cars; and
determining the first elevator car has an available ratio that is less than the ratio of the plurality of elevator cars in response to comparing the ratio of each of the plurality of elevator cars relative to one another.

11. The method of claim 1, wherein each of the plurality of elevator cars includes a counter device configured to count the number of occupants within each of the plurality of elevator cars.

12. The method of claim 1, further comprising:
receiving motion data from the plurality of elevator cars, wherein the motion data includes the current location, a travel speed, a travel direction of the plurality of elevator cars.

13. The method of claim 12, further comprising:
assigning the call from the first location to the first elevator car with the travel speed that is greater than the travel speed of the plurality of elevator cars.

14. The method of claim 12, further comprising:
assigning the call from the first location to the first elevator car with the travel direction that is directed toward the first location.

15. The method of claim 12, further comprising:
determining a distance between the first location and the current location of the plurality of elevator cars; and
assigning the call from the first location to the first elevator car with a offset distance between the first location and the current location that is less than the distance between the first location and the current location of the plurality of elevator cars.

16. A system for dispatching a plurality of elevator cars, comprising:
at least one call device positioned at a plurality of locations, the at least one call device is configured to transmit a call for at least one of the plurality of elevator cars from a first location of the plurality of locations;
at least one counter device positioned in the plurality of elevator cars, the at least one counter device is configured to count a number of occupants in the plurality of elevator cars; and
a dispatch controller operably coupled to the at least one call device at the plurality of locations and the at least one counter device in the plurality of elevator cars such that the dispatch receives data indicative of the call and the number of occupants in the plurality of elevator cars;
wherein the dispatch controller is configured to determine an occupant capacity for each of the plurality of elevator cars from
the number of occupants in the plurality of elevator cars; and
a number of calls assigned to the plurality of elevator cars and positioned between a current location of the plurality of elevator cars and the first location; and
wherein the dispatch controller is configured to assign the call from the first location to a first elevator car with an available occupant capacity that is greater than the occupant capacity of the plurality of elevator cars.

17. The system of claim 16, wherein the dispatch controller is configured to determine a total occupancy for each of the plurality of elevator cars by computing an aggregate of
the number of occupants within the plurality of elevator cars; and
the number of calls assigned to the plurality of elevator cars and positioned between the current location of the plurality of elevator cars and the first location.

18. The system of claim 17, wherein the dispatch controller is configured to determine
a ratio between the total occupancy of each of the plurality of elevator cars with a maximum occupancy capacity of each of the plurality of elevator cars; and
the first elevator car has an available ratio that is greater than the ratio of the plurality of elevator cars in response to comparing the ratio of each of the plurality of elevator cars relative to one another.

19. The system of claim 16, wherein the dispatch controller is configured to determine
a number of occupants at the location of each of the calls assigned to the plurality of elevator cars, wherein the counter device is configured to generate data indicative of the number of occupants at the location of each of the calls;
a total occupancy by computing an aggregate of the number of occupants within each of the plurality of elevator cars and the number of occupants at the location of each of the calls assigned to the plurality of elevator cars; and
determining a ratio of the total occupancy of each of the plurality of elevator cars relative to a maximum occupancy capacity of each of the plurality of elevator cars, wherein the first elevator car has an available ratio that is less than the ratio of the plurality of elevator cars.

20. A system for controlling traffic flow of a plurality of elevator cars, comprising:
a processor; and
a memory storing instructions that, when executed by the processor, causes the processor to perform operations including:
receiving a call for at least one of the plurality of elevator cars, wherein the call is from a first location of a plurality of locations;
determining an occupant capacity for each of the plurality of elevator cars by
determining a number of occupants within the plurality of elevator cars; and
determining a number of calls assigned to the plurality of elevator cars and positioned between a current location of the plurality of elevator cars and the first location; and
assigning the call from the first location to a first elevator car with an available occupant capacity that is greater than the occupant capacity of the plurality of elevator cars.
